(19) United States
(12) Patent Application Publication
(10) Pub. No.: US 2018/0311999 A1
(43) Pub. Date: Nov. 1, 2018

(54) FRAMELESS PAINTING STRUCTURE

(71) Applicant: Yu-Seng TSAI, Hsinchu City (TW)

(72) Inventor: Yu-Seng TSAI, Hsinchu City (TW)

(21) Appl. No.: 15/885,372

(22) Filed: Jan. 31, 2018

(30) Foreign Application Priority Data
Apr. 26, 2017 (TW) 106205854

(51) Int. Cl. B44C 5/02; B41M 3/00; B44F 7/00; C09J 7/20

(52) U.S. Cl. CPC B44C 5/02; C09J 7/20; B44F 7/00; B41M 3/005

(57) ABSTRACT

A frameless painting structure includes a foam board, a painting layer and a plurality of double-sided adhesives. The foam board includes a first surface and a second surface opposite with each other and a circumferencing surface formed between the first surface and the second surface. The painting layer is covered onto the first surface and the circumferential surface. The double-sided adhesives are attached on the second surface. Accordingly, with the foam board being a solid board and the characteristics of the material thereof, the foam board has the merits of stable structure, light weight and resistance to moisture. Consequently, the frameless painting structure is able to achieve the technical effects of improved structural strength, reduced weight and resistance to humidity and moisture.

### BACKGROUND OF THE INVENTION

### Field of the Invention

The technical field is related to a painting structure, in particular, to a frameless painting structure.

### Description of Related Art

Modern people value beauty and style of living greatly, and artistic works, such as photography creations or paintings etc., are often displayed on interior walls of homes for decoration purposes. A frameless painting mainly attaches a painting paper onto a wooden frame or wooden board directly; therefore, frameless painting has the merits of a frameless design and large image output. Therefore, currently, a greater number of artistic works of photography creations or paintings available in the market use the frameless method for presentation.

However, the aforementioned frameless work is associated with the following drawbacks. If a frameless painting is constructed by wooden frames, the painting paper is prone to damages of holes or cracks when the central portion of the frameless painting is subject to piercing or collision. If a frameless painting is constructed by using wooden boards, then the overall weight of the frameless painting can be heavy. Accordingly, there is a need to improve the structural strength of a frameless painting while reducing the weight of the frameless painting, which is a key to the research and development in the industry.

In view of the above, the inventor seeks to overcome the aforementioned drawbacks by presenting a unique solution after years of research and development along with utilization of acidimetric theories as the goal of the present invention.

### SUMMARY OF THE INVENTION

The present invention provides a frameless structure, which utilizes the characteristics of a foam board as a solid board and the material of the board in order to allow the foam board to have the merits of stable structure, light weight and resistance to moisture; therefore, the frameless painting structure of the present invention is able to achieve the technical effects of increasing the structural strength, reducing weight and preventing humidity and moisture.

According to an exemplary embodiment of the present invention, a frameless painting structure is provided. The frameless painting structure comprises: a foam board having a first surface and a second surface opposite with each other and a circumferencing surface formed between the first surface and the second surface; a painting layer covered onto the first surface and the circumferential surface; and at least one double-sided adhesive attached on the second

In view of the above, the comparison between the foam board and the known wooden frame or wooden board of the same volume, the weight of the foam board is much lighter such that the issue of heavy weight when the thickness of the foam board is increased can be overcome. As a result, the thickness of the frameless painting structure can be increased with ease and to present a greater stereoscopic visual sensation.

### BRIEF DESCRIPTION OF DRAWING

FIG. 1 is a perspective exploded view of the frameless painting structure according to a first exemplary embodiment of the present invention;

FIG. 2 is a perspective assembly view of the frameless painting structure according to the first exemplary embodiment of the present invention;

FIG. 3 is another perspective assembly view of the frameless painting structure according to the first exemplary embodiment of the present invention;

FIG. 4 is a schematic view showing a state of use of the frameless painting structure according to the first exemplary embodiment of the present invention;

FIG. 5 is a cross sectional view of the frameless painting structure according to a second exemplary embodiment of the present invention; and

FIG. 6 is a cross sectional view of the frameless painting structure according to a third exemplary embodiment of the present invention.

### DETAILED DESCRIPTION OF THE INVENTION

The following provides a detailed technical content of the present invention along with the accompanied drawings. However, the accompanied drawings are provided for reference and illustrative purpose only such that they shall not be used to limit the scope of the present invention.

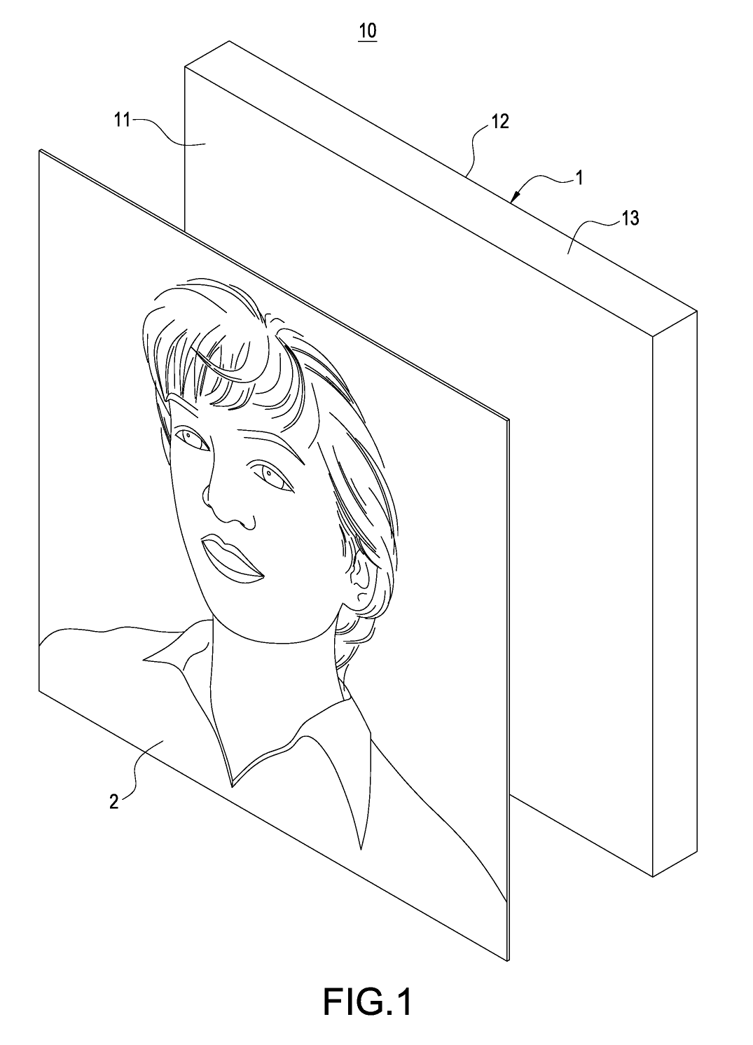

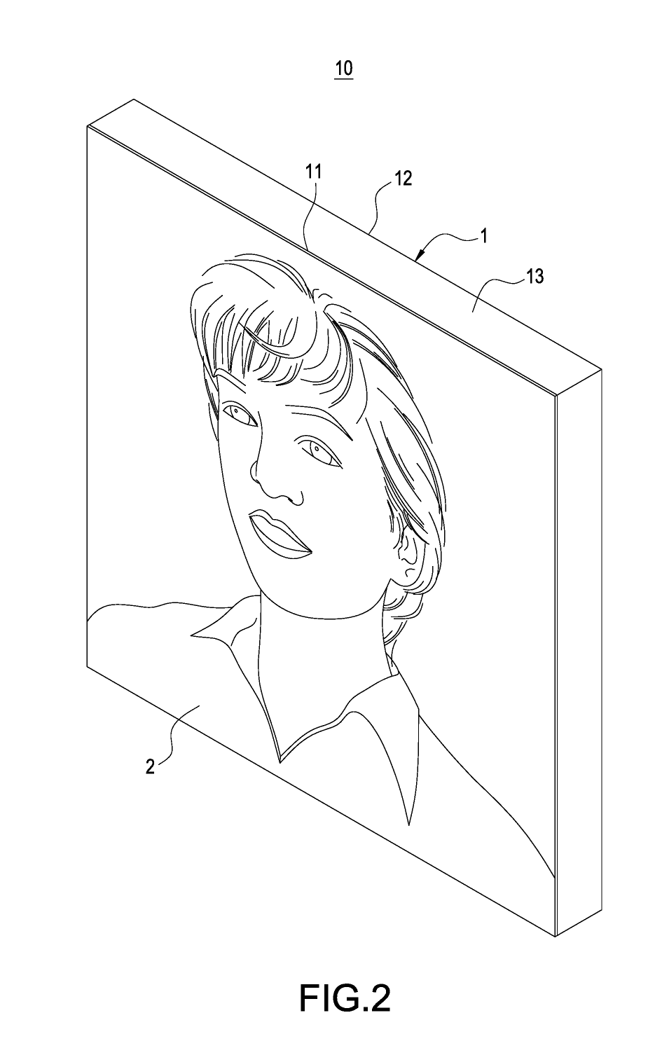

Please refer to FIG. 1 to FIG. 4, according to a first embodiment of the present invention, a frameless painting structure is provided, and the frameless painting structure 10 mainly comprises a foam board, a painting layer 2 and a plurality of double-sided adhesives 3.

As shown in FIG. 1 to FIG. 4, the foam board 1 is a solid board selected from any one of a KT composite board, PVC foam board, a PP foam board, a GatorFoam board, a paper foam board, a Styrofoam board, a polystyrene (PS) board and an EPE board etc. The foam board 1 includes a first surface 11 and a second surface 12 opposite with each other and a circumferential surface 13 formed between the first surface 11 and the second surface 12. In addition, in the first exemplary embodiment of the present invention, the foam board 1 is a polygonal board such that the second surface 12 includes a plurality of corner areas 121. However, the foam board 1 can also be a geometric board having the shape of a circuit, eclipse and polygon etc. such that the present invention is not limited to such embodiment only.

As shown in FIG. 1 to FIG. 4, the painting layer 2 is covered onto the first surface 1. In addition, the painting layer 2 can be formed by a painting paper attached onto a first surface 11. Alternatively, the painting layer 2 can be formed by a printing layer printed onto the first surface 11.

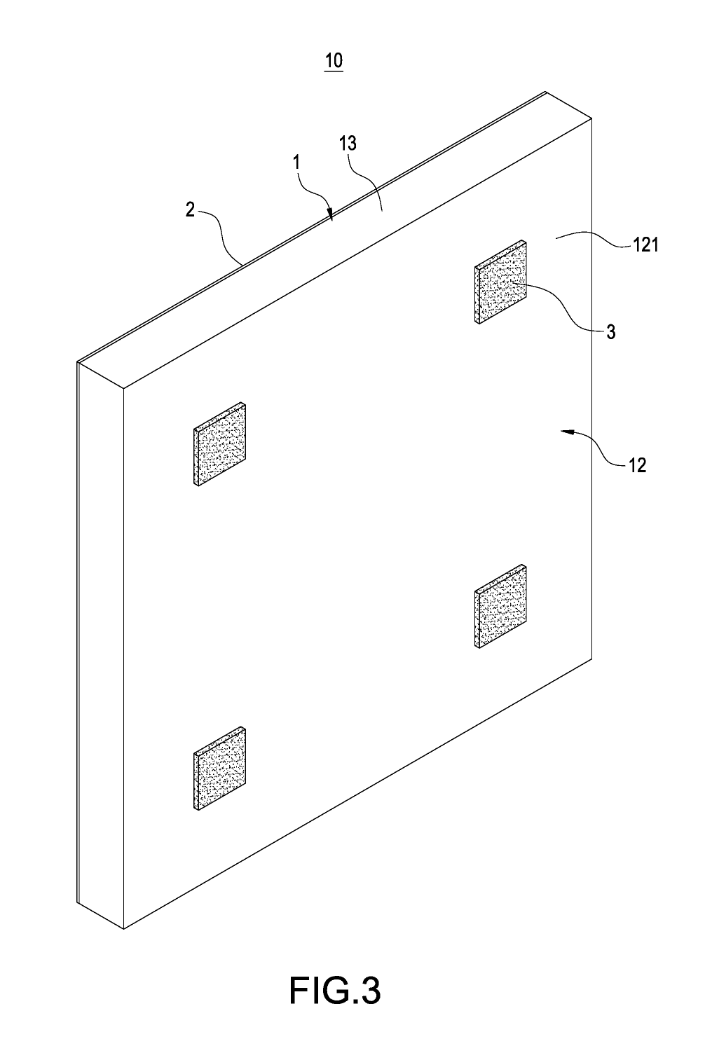

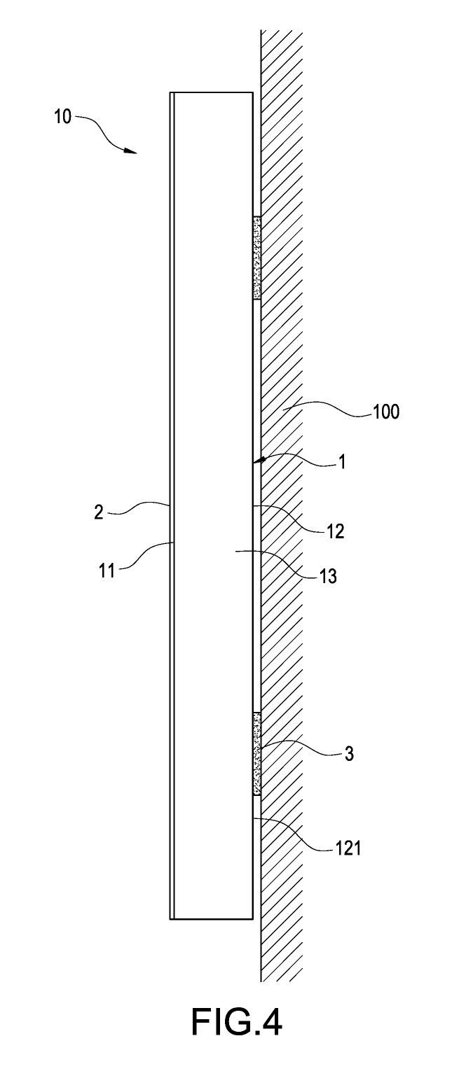

As shown in FIG. 3 to FIG. 4, the double-sided adhesives 3 are attached onto the second surface 12 in order to allow the frameless painting structure 10 to be repetitively attached onto the wall surface 100 with the double-sided adhesives 3 such that the objective of decorating an interior environment can be achieved. In addition, in an exemplary embodiment of the present invention, the double-sided adhesive 3 is a foam double-sided tape. Furthermore, in an exemplary embodiment of the present invention, the quantity of the double-sided adhesive 3 is plural, and each double-sided adhesive 3 is attached onto each corner area 121 respectively; however, the present invention is not limited to such configuration only.

As shown in FIG. 1 to FIG. 4, an assembly of the frameless painting structure 10 according to the first exemplary embodiment of the present invention utilizes the foam board 1 having the first surface 11 and the second surface 12 opposite with each other. The painting layer 2 is covered onto the first surface 11, and the double-sided adhesive 3 is attached onto the second surface 12. Accordingly, since the foam board 1 is a solid board and due to the characteristics of the material, the foam board 1 has the merits of stable structure, light weight and resistance to moisture in order to achieve the technical effects of enhanced structural strength, reduced weight and resistance to humidity and moisture of the frameless painting structure 10.

In addition, the comparison between the foam board 1 and the known wooden frame or wooden board of the same volume, the weight of the foam board 1 is lighter; therefore, when the thickness of the foam board 1 is increased, it would not cause the issue of heavy weight due to the increase of volume. As a result, the thickness of the frameless painting structure 10 can be increased more easily and the stereoscopic visual sensation can be enhanced.

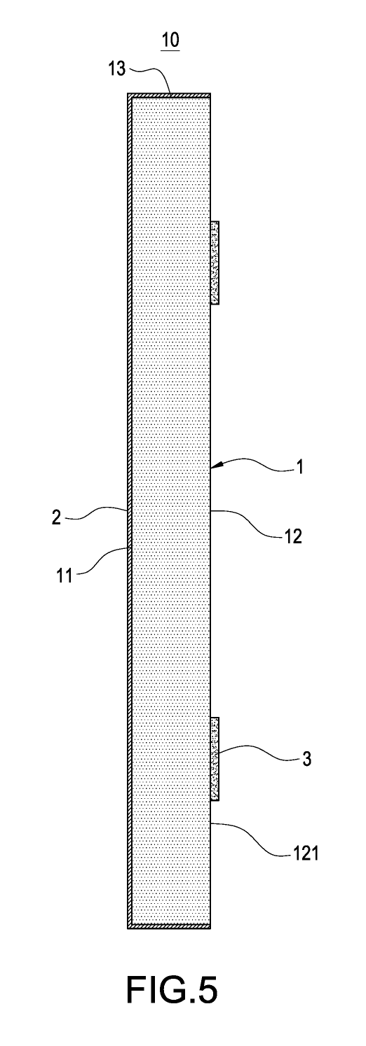

FIG. 5 shows a second exemplary embodiment of the frameless painting structure 10 of the present invention, and the second exemplary embodiment as shown in FIG. 5 is generally identical to the first exemplary embodiment as shown in FIG. 1 to FIG. 4. The difference between the second exemplary embodiment of FIG. 5 and the first exemplary embodiment as shown in FIG. 1 to FIG. 4 relies in that the painting layer 2 is covered onto the first surface 11 and the circumferential surface 13.

Please refer to the following detailed description. The painting layer 2 covers the first surface 11 and the circumferential surface 13 in order to allow the painting layer 2 to be able to cover the circumferential surface 13 such that colors can be presented on the circumferential surface of the painting layer 2. Consequently, the visual sensation is more consistent and the appealing effect of the frameless painting structure 10 can be enhanced.

Furthermore, the painting layer 2 can be formed by a painting paper attached onto the first surface 11 and the circumferential surface 13. Alternatively, the painting paper 2 can be formed by a printing layer printed onto the first surface 11 and the circumferential surface 13.

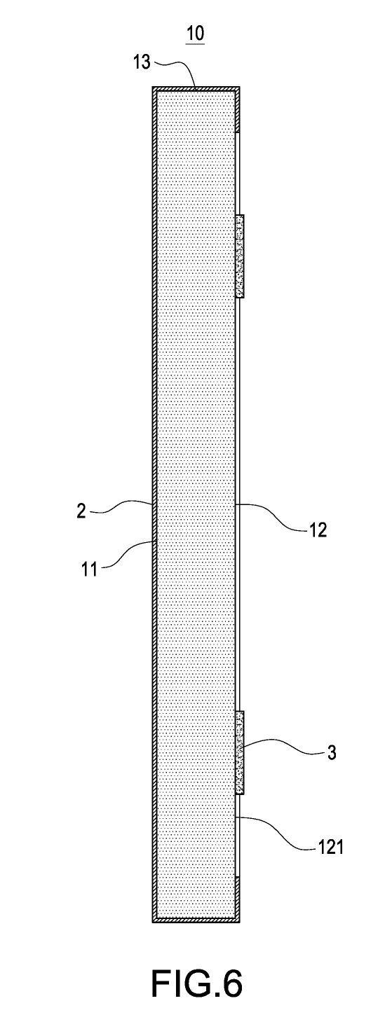

FIG. 6 shows a third exemplary embodiment of the frameless painting structure 10 of the present invention, and the third exemplary embodiment as shown in FIG. 6 is generally identical to the second exemplary embodiment as shown in FIG. 5. The difference between the third exemplary embodiment of FIG. 6 and the second exemplary embodiment of FIG. 5 relies in that the painting layer 2 further covers a portion of the second surface 12.

Please refer to the following detailed description. The painting layer 2 covers portions of the first surface 11, the circumferential surface 13 and the second surface 12 in order to allow the painting layer to further cover the circumferential surface 13 completely such that the colors can be presented on the circumferential edge of the painting layer 2. Consequently, it is able to provide a more consistent visual sensation and the appealing effect of the frameless painting structure 10 can be enhanced. In addition, the painting layer 2 can be more stably attached onto the foam board 1.

Moreover, the painting layer 2 can be formed by a painting layer attached onto portions of the first surface 11, the circumferential surface 13 and the second surface 12. Alternatively, the painting layer 2 can be formed by a printing layer printed onto portions of the first surface 11, the circumferential surface 13 and the second surface 12.

In view of the above, the frameless painting structure of the present invention is able to achieve the expected objectives and overcome the drawbacks of known arts. In addition, the above describes the preferable and feasible exemplary embodiments of the present invention for illustrative purposes only, which shall not be treated as limitations of the scope of the present invention. Any equivalent changes and modifications made in accordance with the scope of the claims of the present invention shall be considered to be within the scope of the claim of the present invention.

What is claimed is:

1. A frameless painting structure, comprising:
a foam board (1) having a first surface (11) and a second surface (12) opposite with each other and a circumferencing surface (13) formed between the first surface (11) and the second surface (12);
a painting layer (2) covered onto the first surface (11) and the circumferential surface (13); and
at least one double-sided adhesive (3) attached on the second surface (12).

2. The frameless painting structure according to claim 1, wherein the foam board (1) is selected from any one of a KT composite board, a PVC foam board, a PP foam board, a GatorFoam board, a paper foam board, a Styrofoam board, a PS board and an EPE board.

3. The frameless painting structure according to claim 1, wherein the painting layer (2) is formed by a painting paper attached onto the first surface (11) and the circumferencing surface (13).

4. The frameless painting structure according to claim 1, wherein the painting layer (2) is formed by a printing layer printed onto the first surface (11) and the circumferential surface (13).

5. The frameless painting structure according to claim 1, wherein the painting layer (2) further covers a portion of the second surface (12).

6. The frameless painting structure according to claim 5, wherein the painting layer (2) is formed by a painting paper attached onto portions of first surface 11), the circumferential surface (13) and the second surface (12).

7. The frameless painting structure according to claim 5, wherein the painting layer (2) is formed by a printing layer printed onto portions of first surface 11), the circumferential surface (13) and the second surface (12).

8. The frameless painting structure according to claim 1, wherein the double-sided adhesive (3) is a foam double-sided tape.

9. The frameless painting structure according to claim 1, wherein a quantity of the double-sided adhesive (3) is plural; the foam board (1) is a polygonal board; the second surface (12) includes a plurality of corner areas (121); and each of the double-sided adhesives (3) is attached onto each of the corner areas (121) respectively.
